(19) United States
(12) Patent Application Publication
(10) Pub. No.: US 2025/0266877 A1
(43) Pub. Date: Aug. 21, 2025

(54) UPLINK CONTROL INFORMATION (UCI) FOR NON-PRECODING MATRIX INDICATOR (PMI)-BASED CHANNEL STATE INFORMATION (CSI)

(71) Applicant: QUALCOMM Incorporated, San Diego, CA (US)

(72) Inventors: Chenxi HAO, Beijing (CN); Pranay Sudeep RUNGTA, New York, NY (US); Yu ZHANG, San Diego, CA (US); Lei XIAO, San Diego, CA (US)

(21) Appl. No.: 18/685,803

(22) PCT Filed: Nov. 5, 2021
(86) PCT No.: PCT/CN2021/128885

§ 371 Date: Feb. 22, 2024

(30) Foreign Application Priority Data
Oct. 16, 2021 (WO) PCT/CN2021/124247

(51) Int. Cl. H04B 7/06; H04W 72/21

(52) U.S. Cl. CPC H04B 7/0626; H04B 7/063; H04B 7/0632; H04W 72/21

(57) ABSTRACT

In an aspect, a method of wireless communication by a user equipment (UE), includes generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI; and transmitting, to a base station, the non-PMI-based CSI report that includes the RI having the first bit-width. In another aspect, a method of wireless communication by a base station includes transmit, to a UE, a CSI reporting configuration having a report quantity field with a value of “cri-ri-cqi;” and receiving, in response to the CSI reporting configuration, a non-PMI-based CSI report from the UE, wherein the non-PMI-based CSI report includes an RI with a first bit-width.

### CROSS-REFERENCE TO RELATED APPLICATIONS

This application is a 37 U.S.C. 371 national stage of International Patent Application No. PCT/CN2021/128885, filed Nov. 5, 2021, which claims priority to PCT Application No. PCT/CN2021/124247, filed Oct. 16, 2021, the contents of all of which are incorporated by reference herein in their entireties.

### BACKGROUND

The present disclosure relates generally to wireless communication systems, and more particularly, to channel state information (CSI) feedback in wireless communication.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, methods, computer-readable mediums, and apparatuses are provided.

In an aspect, a method of wireless communication by a user equipment (UE) includes generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI. The method further includes transmitting, to a base station, the non-PMI-based CSI report that includes the RI having the first bit-width.

In a further aspect, an apparatus for wireless communication by a UE includes a memory and at least one processor coupled with the memory. The at least one processor is configured to generate a non-precoding matrix indicator (PMI)-based channel state information (CSI) report, wherein the non-PMI-based CSI report includes a rank indicator (RI), wherein generating the non-PMI-based CSI report includes determining a first bit-width for the RI. The at least one processor is further configured to transmit, to a base station, the non-PMI-based CSI report that includes the RI having the first bit-width.

In another aspect, an apparatus for wireless communication by a UE includes means for generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI. The apparatus further includes means for transmitting, to a base station, the non-PMI-based CSI report that includes the RI having the first bit-width.

In a further aspect, a non-transitory computer-readable medium stores computer executable code. The computer executable code, when executed by a processor of a UE, causes the processor to generate a non-precoding matrix indicator (PMI)-based channel state information (CSI) report, wherein the non-PMI-based CSI report includes a rank indicator (RI), wherein generating the non-PMI-based CSI report includes determining a first bit-width for the RI. The computer executable code, when executed by the processor of the UE, further causes the processor to transmit, to a base station, the non-PMI-based CSI report that includes the RI having the first bit-width.

In an aspect, a method of wireless communication by a base station includes transmitting, to a user equipment (UE), a channel state information (CSI) reporting configuration having a report quantity field with a value of “cri-ri-cqi.” The method further includes receiving, in response to the CSI reporting configuration, a non-precoding matrix indicator (PMI)-based channel state information (CSI) report from the UE, wherein the non-PMI-based CSI report includes a rank indicator (RI) with a first bit-width.

In a further aspect, an apparatus for wireless communication by a base station includes a memory and at least one processor coupled with the memory. The at least one processor is configured to transmit, to a user equipment (UE), a channel state information (CSI) reporting configuration having a report quantity field with a value of “cri-ri-cqi.” The at least one processor is further configured to receive, in response to the CSI reporting configuration, a non-precoding matrix indicator (PMI)-based channel state information (CSI) report from the UE, wherein the non-PMI-based CSI report includes a rank indicator (RI) with a first bit-width.

In another aspect, an apparatus for wireless communication by a base station includes means for transmitting, to a user equipment (UE), a channel state information (CSI) reporting configuration having a report quantity field with a value of “cri-ri-cqi.” The apparatus further includes means for receiving, in response to the CSI reporting configuration, a non-precoding matrix indicator (PMI)-based channel state information (CSI) report from the UE, wherein the non-PMI-based CSI report includes a rank indicator (RI) with a first bit-width.

In a further aspect, a non-transitory computer-readable medium stores computer executable code. The computer executable code, when executed by a processor of a base station, causes the processor to transmit, to a user equipment (UE), a channel state information (CSI) reporting configuration having a report quantity field with a value of “cri-ri-cqi.” The computer executable code, when executed by the processor of the base station, further causes the processor to receive, in response to the CSI reporting configuration, a non-precoding matrix indicator (PMI)-based channel state information (CSI) report from the UE, wherein the non-PMI-based CSI report includes a rank indicator (RI) with a first bit-width.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of a wireless communication system and an access network, including at least one user equipment (UE) and at least one base station, each having a respective channel state information (CSI) component configured to perform CSI reporting, in accordance with various aspects of the present disclosure.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a block diagram of example components of the UE and the base station of FIG. 1 communicating in an access network, in accordance with various aspects of the present disclosure.

FIG. 4 is a flowchart of an example method of wireless communication by a UE, in accordance with various aspects of the present disclosure.

FIG. 5 is a flowchart of an example method of wireless communication by a base station, in accordance with various aspects of the present disclosure.

FIG. 6 is a block diagram of example components of the UE of FIG. 1, in accordance with various aspects of the present disclosure.

FIG. 7 is a block diagram of example components of the base station of FIG. 1, in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G New Radio (NR), the concepts described herein may be applicable to other similar areas, such as Long Term Evolution (LTE), LTE Advanced (LTE-A), code division multiple access (CDMA), Global System for Mobile Communications (GSM), and other wireless technologies.

Aspects of the present disclosure allow for reporting non-precoding matrix indicator (PMI)-based channel state information (CSI). In some aspects, a base station may configure a user equipment (UE) for reporting non-PMI-based CSI, for example, by sending a channel state information (CSI) reporting configuration having a report quantity field with a value of “cri-ri-cqi.” In response, the UE may send a non-PMI-based CSI. In doing so, the UE may use specified bit-widths for reporting various information in the CSI, such as specified bit-widths for reporting a rank indicator (RI), a layer indicator (LI), a CSI-reference signal (CSI-RS) resource indicator (CRI), etc. For example, in some aspects, a bit-width for reporting RI may be calculated based on a number of allowable ranks, a maximum allowable rank, etc. For example, in aspects where different resources have different rank hypothesis, a bit-width for reporting RI may be calculated based on a total number of different allowable ranks across all resources, a maximum number of allowable ranks across all resources, a maximum allowable rank across all resources, a maximum and a minimum allowable rank across all resources, etc. In some non-limiting aspects, RI codepoints may be mapped to ranks in increasing order.

In some aspects, performance improvements may be achieved by configuring non-PMI-based CSI. Specifically, for example, code-book-based CSI may be needed in frequency division duplex (FDD) systems where a base station is not able to determine the precoder based on the uplink signal and therefore the base station just transmits on some non-precoded ports. In this case, each non-precoded port corresponds to a transmit chain, and the UE has to find out the PMI in order to efficiently combine the ports together to transmit a layer. However, in time division duplexing (TDD) systems, because there is uplink-downlink reciprocity, the base station knows the best procoder based on the uplink signal. Therefore, the base station may transmit some precoded ports, where a port corresponds to a layer. In this case, the UE only needs to determine how many layers are needed and which ports (e.g., layers in the context of the non-PMI based CSI reporting) are to be selected. Accordingly, unlike FDD systems where the codebook is just a predefined set which may not map with the perfect procoder and may suffer from payload issues, in TDD systems the base station may determine any type of precoder to transmit the port, and the actual precoder may be determined by the base station based on the uplink signal. Therefore, the precoder chosen by the base station may better map with the optimal precoder and thus result in improved performance.

Additional features of the present aspects are described in more detail below with reference to the appended drawings.

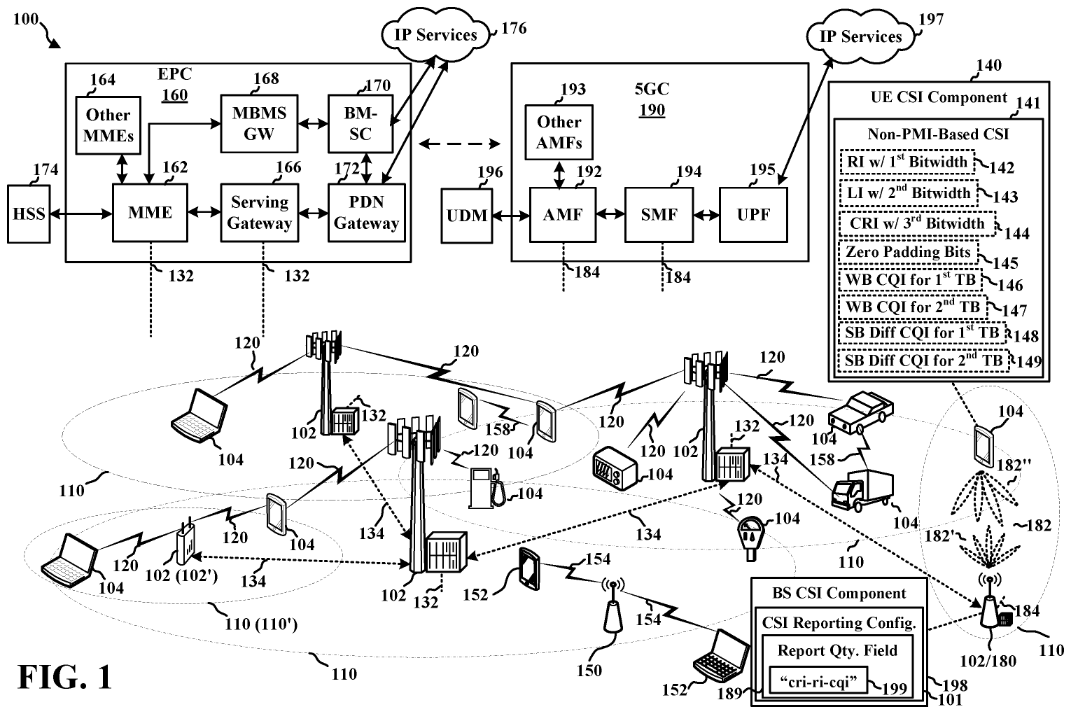

Referring to FIG. 1, in accordance with various aspects of the present disclosure, an example wireless communications system and access network 100 includes a user equipment (UE) 104 having a UE CSI component 140 and a base station 102 (e.g., a gNB) having a base station CSI component 198, wherein the UE CSI component 140 and the base station CSI component 198 are respectively configured to implement CSI reporting for wireless communication between the UE 104 and the base station 102. In an aspect, in order to configure the UE 104 for reporting a non-PMI-based CSI 141, the base station CSI component 198 generates a CSI reporting configuration 101 having a report quantity field 189 that is set to “cri-ri-cqi” 199, and sends the CSI reporting configuration 101 to the UE 104. In response, the UE 104 generates the non-PMI-based CSI 141 and sends the non-PMI-based CSI 141 to the base station 102. The UE 104 may use various specified bit-widths for information that is reported in the non-PMI-based CSI 141, such as an RI with a first bit-width 142, an LI with a second bit-width 143, and/or a CRI with a third bit-width 144. The non-PMI-based CSI 141 may also include one or more zero padding bits 145, a wide-band channel quality indicator (CQI) for a first transport block (TB) 146, a wide-band CQI for a second TB 147, a side-band differential CQI for the first TB 148, a side-band differential CQI for the second TB 149, etc. It is noted that the illustrated order of various information in the non-PMI-based CSI 141 in FIG. 1 is only for illustrative purposes, and the present aspects are not limited to the illustrated order of such information in FIG. 1. Instead, the various information in the non-PMI-based CSI 141 may be packed according to one or more specified mapping orders as described below with reference to various example aspects.

Further details of the operation of the UE CSI component 140 of the UE 104 and the base station CSI component 198 of the base station 102 are described below with reference to the appended drawings.

The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, and 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, e.g., including synchronization signals. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same (e.g., 5 GHZ, or the like) unlicensed frequency spectrum as may be used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include an eNB, gNodeB (gNB), or another type of base station. Some base stations, such as gNB 180 may operate in a traditional sub-6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

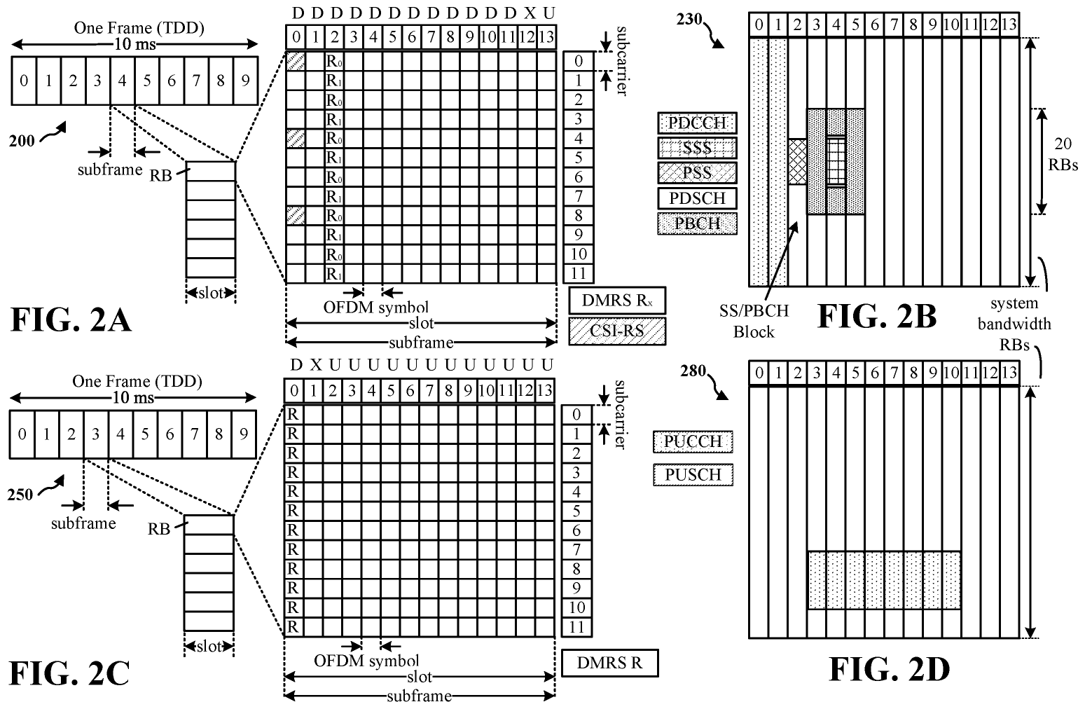

Referring to FIGS. 2A-2D, one or more example frame structures, channels, and resources may be used for communication between the base stations 102 and the UEs 104 of FIG. 1. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some aspects, for configuring codebook-based CSI (e.g., PMI-based CSI), a base station may set the field of report quantity in a “CSI-ReportConfig” to “cri-ri-pmi-cqi” or “cri-ri-i1” or “cri-ri-i1-cqi.” The base station may also set the “codebookConfig” to a codebook type, e.g., type1, type2, etc. Such CSI report settings cause a UE to report a CSI with the configured codebook type, where the reporting quantity of the CSI may include CRI, RI, PMI, and/or CQI.

In uplink control information (UCI) packing for codebook-based CSI, various bit-widths are specified for each field of the reporting content of the CSI. For example, for type I codebook (e.g., when “codebookType=typeI-SinglePanel”), RI is reported using min (┌log₂ P┐, ┌log₂ N_{RI}┐) bits, LI is reported using min (2, ν) bits, wide-band CQI is reported using 4 bits per TB, sub-band CQI is reported using 2 bits per sub-band per TB, and CRI is reported using ┌log₂ Kₛ^{CSI-RS}┐ bits. In the above, n_{RI} is the number of allowed RI values, ν is the reported rank, Kₛ^{CSI-RS} is the number of CSI-RS resources, and P is the number of ports per CSI-RS resource.

For example, referring to Table 1 below, in some non-limiting aspects where “codebookType-typeI-SinglePanel,” various bit-widths are specified for each field in the CSI.

TABLE 1
RI, LI, CQI, and CRI of codebookType = typeI-SinglePanel

| | Bit-width | | | | |
|---|---|---|---|---|---|
| | 1 antenna | 2 antenna | 4 antenna | >4 antenna ports | |
| Field | port | ports | ports | Rank1~4 | Rank5~8 |
| Rank | 0 | min (1, | min (2, | ┌log₂ n_{RI}┐ | ┌log₂ n_{RI}┐ |
| Indicator | | ┌log₂ n_{RI}┐) | ┌log₂ n_{RI}┐) | | |
| Layer | 0 | ┌log₂ v┐ | min (2, | min (2, | min (2, |
| Indicator | | | ┌log₂ v┐) | ┌log₂ v┐) | ┌log₂ v┐) |
| Wide-band | 4 | 4 | 4 | 4 | 4 |
| CQI for the | | | | | |
| first TB | | | | | |
| Wide-band | 0 | 0 | 0 | 0 | 4 |
| CQI for the | | | | | |
| second TB | | | | | |
| Sub-band | 2 | 2 | 2 | 2 | 2 |
| differential | | | | | |
| CQI for the | | | | | |
| first TB | | | | | |
| Sub-band | 0 | 0 | 0 | 0 | 2 |
| differential | | | | | |
| CQI for the | | | | | |
| second TB | | | | | |
| CRI | ┌log₂ | ┌log₂ | ┌log₂ | ┌log₂ | ┌log₂ |
| | (Kₛ^{CSI-RS})┐ | (Kₛ^{CSI-RS})┐ | (Kₛ^{CSI-RS})┐ | (Kₛ^{CSI-RS})┐ | (Kₛ^{CSI-RS})┐ |

Also, in some non-limiting aspect where “codebookType=typeI-SinglePanel,” depending on various configurations such as the rank or rank pair, the number of CSI-RS ports, the codebook mode, etc., respective bit-widths are specified for the PMI reporting fields such as information field X1 for wide-band PMI and information field X2 for wide-band PMI or per sub-band PMI.

In some other aspects, for configuring non-PMI-based CSI, the base station may set the field of report quantity in the “CSI-ReportConfig” to “cri-ri-cqi.” In response, the UE assumes that each CSI-RS port corresponds to a layer (that is, no codebook is needed/configured), and selecting an RI means selecting RI ports from the total P of CSI-RS ports. In an aspect, a port corresponds to a logical transmission stream, which may be formed by assigning weights to one or more transmit/receive chains. For each rank hypothesis, the RI ports out of P may be configured or may be fixed. When configured, the RI ports for each rank hypothesis are provided by “non-PMI-PortIndication.”The “non-PMI-PortIndication” fields include a set of configuration fields “PortIndexFor8Ranks,” where each configuration field “PortIndexFor8Ranks” provides a port-sequence for a CSI-RS resource associated with the CSI report configuration. For example, for rank hypothesis ν, the base station provides the port sequence p₀^{(ν)}, p₁^{(ν)}, . . . , p_{ν-1}^{(ν)}. The port sequence for each rank hypothesis may be different. The number of ports per CSI-RS resource may be, for example, P∈{1,2,4,8}, while the possible rank hypothesis may be, for example, {1, 2, . . . , P}. In some aspects, the base station may not necessarily provide a port sequence for all possible rank hypothesis. For example, for P=8, the network may only provide a port sequence for rank 1 and rank 3. In this case, other ranks (2, 4,5,6,7,8) are not supported. If “non-PMI-PortIndication” is not configured (e.g., is absent), the UE assumes that a fixed port selection sequence p₀ (ν), p₁^{(ν)}, . . . , p_{ν-1}^{(ν)}={0, . . . , ν−1} is used for rank ν. The “PortIndexFor8Ranks” is provided per CSI-RS resource associated with the CSI report configuration. Accordingly, for example, the rank hypothesis and port-sequence for CSI-RS resource 1 may be different from the rank hypothesis and port-sequence for CSI-RS resource 2.

Some aspects of the present disclosure specify bit-widths for one or more values that are reported in a non-PMI-based CSI, e.g., CRI, RI, LI, and/or CQI.

In one non-limiting aspect, for example, for CSI reporting with non-PMI-based CSI (report quantity=“cri-ri-cqi”), RI is reported using a bit-width that depends on the number of allowable ranks or rank pairs (e.g., for multi transmission reception point (mTRP) non-coherent joint transmission (NCJT) CSI), and the values of the RI field are mapped to allowed RI values with increasing order, where “0” is mapped to the smallest allowed RI value. In an aspect, for example, the bit-width for RI is ┌log₂ N_{RI}┐ or min (┌log₂ P┐, ┌log₂ N_{RI}┐) bits, where n_{RI} is the number of allowable ranks corresponding to the configured fields of “PortIndexFor8Ranks,” if configured. If not configured, the number of allowable ranks equals the number of total ports per resource. For example, if only port sequences for rank 1 and rank 3 are provided, then one bit is used, where codepoint “0” corresponds to rank 1, and codepoint “1” corresponds to rank 3.

In some aspects, the fields “PortIndexFor8Ranks” are different for different CSI-RS resources, and the bit-width for RI is ┌log₂ n_{RI}┐ or min (┌log₂ P┐, ┌log₂ n_{RI}┐) bits, where n_{RI} is the maximum number of allowable ranks across all the CSI-RS resources associated with the CSI report configuration corresponding to the configured fields of “PortIndexFor8Ranks” for each CSI-RS resource, if configured. For example, in one non-limiting aspect, if for CSI-RS resource 1, only port sequences for rank 1 and rank 3 are provided, while for CSI-RS resource 2, port sequences for rank 1-4 are provided, then 2 bits are used for reporting RI.

In some aspects, the codepoint mapping may depend on the reported resource, and each codepoint provided by the RI indicator maps to the allowable rank in the selected CSI-RS resource in increasing order, with codepoint “0” mapped to the lowest rank of the selected resource. For example, in one non-limiting aspect, if for CSI-RS resource 1, only port sequences for rank 1 and rank 3 are provided, while for CSI-RS resource 2, port sequences for rank 1-4 are provided, and if the UE selects CSI-RS resource 1 and reports the selection by CRI, then codepoint “00” in RI corresponds to rank 1, codepoint “01” corresponds to rank 3, and the UE does not expect to report codepoint “10” and “11.” Alternatively, if the UE selects CSI-RS resource 2 and reports the selection by CRI, then codepoint “00” in RI corresponds to rank 1, codepoint “01” corresponds to rank 2, codepoint “10” corresponds to rank 3, and codepoint “11” corresponds to rank 4.

In an alternative non-limiting aspect, for example, for CSI reporting with non-PMI-based CSI (report quantity=“cri-ri-cqi”), RI is reported using a bit-width that depends on the maximum allowable rank or rank pair (e.g., for mTRP NCJT CSI) or the number of total ports per CSI-RS resource, and only the codepoints corresponding to the allowable ranks are valid. In an aspect, for example, the bit-width for RI is ┌log₂ n_{RI,max}┐ or ┌log₂ nPorts┐ bits, where n_{RI,max} is the maximum allowable rank corresponding to the configured fields of “PortIndexFor8Ranks,” if configured. If not configured, the number of allowable ranks equals the number of total ports per resource. Also, the values of the RI field are mapped with increasing order, where “0” is mapped to rank 1. For example, if only port sequences for rank 1 and rank 3 are provided, then two bits are used, where codepoint “00” corresponds to rank 1, codepoint “01” corresponds to rank 2, and codepoint “10” corresponds to rank 3. However, only codepoint “00” and “10” may be reported.

In an alternative non-limiting aspect, “PortIndexFor8Ranks” may be different for each resource. In this case, for example, for CSI reporting with non-PMI-based CSI (report quantity=“cri-ri-cqi”), RI is reported using a bit-width that depends on the maximum allowable rank or rank pair (e.g., for mTRP NCJT CSI) or the number of total ports across all CSI-RS resources associated with the CSI report configuration, and only the codepoints corresponding to the allowable ranks are valid. In some aspects, the codepoint mapping does not depend on the reported resource, but the valid codepoints depend on the reported resource. For example, if for CSI-RS resource 1, port sequences for rank 1 and 3 are provided, while for CSI-RS resource 2, port sequences for rank 2 and 4 are provided, then there are 2 bits used to indicate RI, with codepoint “00” corresponding to rank 1, codepoint “01” corresponding to rank 2, codepoint “10” corresponding to rank 3, and codepoint “11” corresponding to rank 4. However, if the UE selects CSI-RS resource 1, only codepoint “00” and “10” may be reported, and if the UE selects CSI-RS resource 2, only codepoint “01” and “11” may be reported. In an alternative non-limiting aspect, RI is reported using a bit-width that depends on the maximum rank associated with the CSI report configuration, and only the codepoints corresponding to the allowable ranks are valid. The codepoint maps to rank in increasing order, with codepoint “000” mapped to rank 1. For example, in an aspect, RI is always reported using 3 bits because the maximum possible rank is 8, and if for a CSI-RS resource, port sequence is only provided for rank 1 and rank 3, then only codepoints “000” and “010” are valid.

In one non-limiting aspect, the UE may further report LI (e.g., which indicates the strongest layer) using a bit-width that depends on the reported value of rank, e.g., ┌log₂ ν┐ bits. The codepoint maps LI in increasing order, with codepoint “0” mapped to layer 0, codepoint “1” mapped to layer 1, etc.

In an alternative non-limiting aspect, the UE may report LI using a bit-width that depends on the number of CSI-RS ports per resource, e.g., ┌log₂ nPorts┐ bits. Specifically, in an aspect, for non-PMI-based CSI reporting where each port corresponds to one layer (e.g., a PDSCH layer), selecting the strongest layer is the same as selecting the strongest point. The codepoint maps the port index in increasing order, with codepoint “0” mapped to port 0, which indicates that the layer conveyed by the indicated port is the strongest.

In one non-limiting aspect, the UE may report CRI with a bit-width that depends on the number of CSI-RS resources.

Referring to Table 2 below, in one non-limiting example aspect, various bit-widths are specified for each field in the CSI when: (A) “codebookType=typeI-SinglePanel,” or (B) higher layer parameter “reportQnantity” is set to “cri-RI-COI”

TABLE 2
RI, LI, CQI, and CRI of codebookType = typeI-SinglePanel or higher
layer parameter reportQuantity set to ‘cri-RI-CQI’

| | Bit-width | | | | |
|---|---|---|---|---|---|
| | 1 antenna | 2 antenna | 4 antenna | >4 antenna ports | |
| Field | port | ports | ports | Rank1~4 | Rank5~8 |
| Rank | 0 | min (1, | min (2, | ┌log₂ n_{RI}┐ | ┌log₂ n_{RI}┐ |
| Indicator | | ┌log₂ n_{RI}┐) | ┌log₂ n_{RI}┐) | | |
| Layer | 0 | ┌log₂ v┐ | min (2, | min (2, | min (2, |
| Indicator | | | ┌log₂ v┐) | ┌log₂ v┐) | ┌log₂ v┐) |
| Wide-band | 4 | 4 | 4 | 4 | 4 |
| CQI for the | | | | | |
| first TB | | | | | |
| Wide-band | 0 | 0 | 0 | 0 | 4 |
| CQI for the | | | | | |
| second TB | | | | | |
| Sub-band | 2 | 2 | 2 | 2 | 2 |
| differential | | | | | |
| CQI for the | | | | | |
| first TB | | | | | |
| Sub-band | 0 | 0 | 0 | 0 | 2 |
| differential | | | | | |
| CQI for the | | | | | |
| second TB | | | | | |
| CRI | ┌log₂ | ┌log₂ | ┌log₂ | ┌log₂ | ┌log₂ |
| | (Kₛ^{CSI-RS})┐ | (Kₛ^{CSI-RS})┐ | (Kₛ^{CSI-RS})┐ | (Kₛ^{CSI-RS})┐ | (Kₛ^{CSI-RS})┐ |

Specifically, for example, for codebook-based CSI when “codebookType-typeI-SinglePanel,” n_{RI} in Table 2 is the number of allowed RI values according to third generation partnership program (3GPP), technical specification (TS) 38.214, Clause 5.2.2.2.1. In an aspect, for example, for codebook-based CSI when “codebookType=typeI-SinglePanel,” n_{RS} in Table 2 is according to the higher layer parameter “typeI-SinglePanel-ri-Restriction” configured in the “codebookConfig.”

Also, for example, for non-PMI-based CSI when higher layer parameter “reportQuantity” is set to “cri-RI-CQI,” np in Table 2 is the number of allowed RI values according to 3GPP, TS 38.214, Clause 5.2.1.4.2. In an aspect, for example, for non-PMI-based CSI when higher layer parameter “reportQuantity” is set to “cri-RI-CQI,” n_{RI} in Table 2 is according to the higher layer parameter “PortIndexFor8Ranks.” In “PortIndexFor8Ranks,” a rank is allowed if a port sequence is provided for that rank. If the port sequence is not provided for a rank, such rank is not supported. In one non-limiting aspect, for example, for non-PMI-based CSI when higher layer parameter “reportQuantity” is set to “cri-RI-CQI,” and for cases where different resources have different rank hypothesis, np in Table 2 is the maximum number of allowed RI values across all CSI-RS resources according to 3GPP, TS 38.214, Clause 5.2.1.4.2, and each codepoint maps to the allowable rank configured to the CSI-RS resource reported via CRI in increasing order with codepoint 0 mapped to the lowest rank configured to the CSI-RS resource reported via CRI.

In another non-limiting aspect, for example, for non-PMI-based CSI when higher layer parameter “reportQuantity” is set to “cri-RI-CQI,” and for cases where different resources have different rank hypothesis, n_{RS} in Table 2 is the maximum allowed RI value across all CSI-RS resources according to 3GPP, TS 38.214, Clause 5.2.1.4.2, and each codepoint maps to a rank in increasing order with codepoint 0 mapped to rank 1.

In yet another non-limiting aspect, for example, for non-PMI-based CSI when higher layer parameter “reportQuantity” is set to “cri-RI-CQI,” and for cases where different resources have different rank hypothesis, n_{RI} in Table 2 is the number of different allowable RI values across all CSI-RS resources associated with the CSI report setting according to 3GPP, TS 38.214, Clause 5.2.1.4.2, and each codepoint maps to an allowable rank in increasing order, with codepoint 0 mapped to the smallest allowable rank across all resources.

In a further non-limiting aspect, for example, for non-PMI-based CSI when higher layer parameter “reportQuantity” is set to “cri-RI-CQI,” and for cases where different resources have different rank hypothesis, ng in Table 2 is based on the difference between the maximum allowable rank across all resources n_{RI,max} and the minimum allowable rank across all resources n_{RI,min} associated with the CSI report setting according to 3GPP, TS 38.214, Clause 5.2.1.4.2. More specifically, for example, n_{RI} may be calculated as n_{RI}=n_{RI,max}−n_{RI,min}+1, and each codepoint maps to an allowable rank in increasing order, with codepoint 0 mapped to the smallest allowable rank across all resources.

Further, ν in Table 2 is the value of the rank. The value of Kₛ^{CSI-RS} in Table 2 is the number of CSI-RS resources in the corresponding resource set. The values of the RI field are mapped to allowed RI values with increasing order, where “0” is mapped to the smallest allowed RI value.

In some aspects, a UCI packing order is specified for code-book-based CSI. For example, referring to Table 3 below, when UCI is transmitted on PUCCH and for wide-band CSI (e.g., when “pmi-FormatIndicator-widebandPMI” and “cqi-FormatIndicator-widebandCQI”), UCI only has one part, and the mapping order of CSI fields of one CSI report is: CRI→RI→LI→zero padding bits→PMI X1→PMI X2→wide-band CQI for first TB→wide-band CQI for second TB.

TABLE 3
Mapping order of CSI fields of one CSI report pmi-FormatIndicator =
widebandPMI and cqi-FormatIndicator = widebandCQI

| CSI report | |
|---|---|
| number | CSI fields |
| CSI report | CRI, if reported |
| #n | Rank Indicator, if reported |
| | Layer Indicator, if reported |
| | Zero padding bits O_{P}, if needed |
| | PMI wide-band information fields X₁, if reported |
| | PMI wide-band information fields X₂, or codebook |
| | index for 2 antenna ports, if reported |
| | Wide-band CQI for the first TB, if reported |
| | Wide-band CQI for the second TB, if reported |

The actual payload may change depending on the reported rank. Accordingly, the zero padding bits are calculated in a way to keep the total payload invariant. In an aspect, the number of zero padding bits O_{P} is zero for one CSI-RS port, and is O_{P}=Nₘₐₓ−N_{reported} for more than one CSI-RS port, where Nₘₐₓ is the maximum possible payload size given the CSI report configuration, and N_{reported} is the reported payload size. In an aspect, for example, Nₘₐₓ is the maximum possible payload size over all possible rank values that are allowed to be reported, and N_{reported} is the reported payload size for the reported rank. In an aspect, for example, N_{reported} IS the sum of the reported payload sizes for reporting PMI, CQI, and LI.

In an alternative aspect when UCI is transmitted on PUCCH and for sub-band CSI (e.g., for either or both of the following: “pmi-FormatIndicator=subbandPMI” or “cqi-FormatIndicator=subbandCQI”), the CSI report includes two parts. The payload of the first part is invariant, while the payload of the second part depends on the values reported in the first part. In an aspect, for example, referring to Table 4 below, the mapping order in CSI part 1 is: CRI→RI→wide-band CQI for first TB→sub-band differential CQI for first TB→indicator of non-zero wide-band amplitude (for Type II CSI).

TABLE 4
Mapping order of CSI fields of one CSI report,
CSI part 1 pmi-FormatIndicator = subbandPMI
or cqi-FormatIndicator = subbandCQI

| CSI report | |
|---|---|
| number | CSI fields |
| CSI report | CRI, if reported |
| #n | Rank Indicator, if reported |
| CSI part 1 | Wide-band CQI for the first TB, if reported |
| | Sub-band differential CQI for the first TB with increasing |
| | order of sub-band number, if reported |
| | Indicator of the number of non-zero wide-band amplitude |
| | coefficients M0 for layer 0, if reported |
| | Indicator of the number of non-zero wide-band amplitude |
| | coefficients M1 for layer 1 (if the rank according to the |
| | reported RI is equal to one, this field is set to all zeros), |
| | if 2-layer PMI reporting is allowed and if reported |

In Table 4, sub-bands for given CSI report n indicated by the higher layer parameter “csi-ReportingBand” are numbered continuously in the increasing order with the lowest sub-band of “csi-ReportingBand” as sub-band 0.

The mapping order for CSI part two is: wide-band terms→sub-band terms. For example, referring to Table 5 below, the mapping order of the wide-band terms is: wide-band CQI for second TB (if rank>4)→LI→PMI X1→PMI X2 (if “pmi-FormatIndicator=widebandPMI”).

TABLE 5
Mapping order of CSI fields of one CSI report,
CSI part 2 wide-band pmi-FormatIndicator =
subbandPMI or cqi-FormatIndicator-subbandCQI

| CSI report | |
|---|---|
| number | CSI fields |
| CSI report | Wide-band CQI for the second TB, if present and reported |
| #n | Layer Indicator, if reported |
| CSI part 2 | PMI wide-band information fields X1, if reported |
| wide-band | PMI wide-band information fields X2, or codebook index for |
| | 2 antenna ports, if pmi-FormatIndicator = widebandPMI |
| | and if reported |

In an aspect, for example, referring to Table 6 below, the mapping order of the sub-band terms is: even sub-band terms→odd sub-band terms. The mapping order in each even and odd sub-band term is: sub-band differential CQI for second TB (if rank>4 and cqi is “cqi-FormatIndicator=subbandCQI”)→PMI X2 (if “pmi-FormatIndicator=subbandPMI”).

TABLE 6
Mapping order of CSI fields of one CSI report, CSI part
2 sub-band pmi-FormatIndicator = subbandPMI or cqi-
FormatIndicator = subbandCQI

| | |
|---|---|
| CSI report | Sub-band differential CQI for the second TB of all even |
| #n | sub-bands with increasing order of sub-band number, |
| Part 2 | if cqi-FormatIndicator = subbandCQI and if reported |
| sub-band | PMI sub-band information fields X2 of all even sub-bands |
| | with increasing order of sub-band number, or codebook index |
| | for 2 antenna ports of all even sub-bands with increasing |
| | order of sub-band number, if pmi-FormatIndicator = |
| | subbandPMI and if reported |
| | Sub-band differential CQI for the second TB of all odd |
| | sub-bands with increasing order of sub-band number, |
| | if cqi-FormatIndicator = subbandCQI and if reported |
| | PMI sub-band information fields X2 of all odd sub-bands |
| | with increasing order of sub-band number, or codebook index |
| | for 2 antenna ports of all odd sub-bands with increasing |
| | order of sub-band number, if pmi-FormatIndicator = |
| | subbandPMI and if reported |

In a further alternative aspect when UCI is transmitted on PUSCH, the UCI packing order is similar to UCI on PUCCH carrying sub-band CSI. Each CSI report has two parts regardless of the format of PMI and CQI. For CSI part 1, the mapping order is similar to UCI on PUCCH, except for an additional field for eType II CSI added at the end. The additional field is “indication of the total number of non-zero coefficients summed across all layers.” For CSI part 2, the mapping order is similar to UCI on PUCCH, except that PMI X1 and PMI X2 component are different when Type II CSI or eType II CSI are configured, because their PMI components are different from Type I single panel CSI. For Type II CSI, PMI X2 parts are still formed according to the following order: even sub-band terms→odd sub-band terms, but detailed components in PMI X2 are different. For eType II CSI, the PMI X2 are not mapped per even/odd sub-band terms. Instead, the PMI X2 are divided into group 0, 1, and 2, and are mapped with group index.

In an aspect of the present disclosure, a mapping order of CRI, RI, LI, and/or CQI is provided for non-PMI-based CSI. The mapping order of non-PMI-based CSI may be different for UCI on PUCCH or PUSCH or for different CQI formats.

In an aspect, for example, referring to Table 7 below, for UCI on PUCCH and wide-band CSI (e.g., wide-band CQI), UCI for non-PMI-based CSI includes one part with the following mapping order: CRI→RI→LI (if LI is included)→zero padding bits→wide-band CQI for first TB→WB CQI for second TB.

TABLE 7
Mapping order of CSI fields of one CSI report reportQuantity set to
‘cri-RI-CQI’ and cqi-FormatIndicator = widebandCQI

| CSI report | |
|---|---|
| number | CSI fields |
| CSI report | CRI, if reported |
| #n | Rank Indicator, if reported |
| | Layer Indicator, if reported |
| | Zero padding bits O_{P}, if needed |
| | Wide-band CQI for the first TB, if reported |
| | Wide-band CQI for the second TB, if reported |

Alternatively, in an aspect, the mapping order of Table 3 for codebook-based CSI (e.g., when “pmi-FormatIndicator=widebandPMI” and “cqi-FormatIndicator=widebandCQI”) may also be used for non-PMI-based CSI (e.g., when “reportQuantity” set is to “cri-RI-CQI” and “cqi-FormatIndicator=widebandCQI”) by omitting PMI reporting fields. For example, the codebook-based CSI mapping order: CRI→RI→LI→zero padding bits→PMI X1→PMI X2→wide-band CQI for first TB→wide-band CQI for second TB may be used for non-PMI-based CSI, except that PMI X1 and PMI X2 in Table 3 are not reported for non-PMI-based CSI.

In Table 7, the number of zeros to be padded is zero for one CSI-RS port, and is O_{P}=Nₘₐₓ−N_{reported} for more than one CSI-RS ports, where Nₘₐₓ is the maximum possible payload size given the CSI report configuration, and N_{reported} is the reported payload size. In an aspect, for example, Nₘₐₓ is the maximum possible payload size over all possible rank values that are allowed to be reported, and N_{reported} is the reported payload size for the reported rank. In an aspect, for example, N_{reported} IS the sum of the reported payload sizes for reporting each field of the CSI. For non-PMI-based CSI, the length of the PMI part of the CSI is zero, therefore O_{P} only depends on LI. In an aspect, for example, the reported payload size is a function of the LI payload size: N_{LI}(r), where N_{LI}(r)=ceil (log 2(r)), where r is the reported rank value.

In another aspect, for UCI on PUCCH with sub-band CQI and for UCI on PUSCH with sub-band/wide-band CSI, the UCI for non-PMI-based CSI includes two parts. The payload of the first part is invariant, while the payload of the second part depends on the values reported in the first part. Referring to Table 8 below, for example, the mapping order in CSI part 1 is: CRI→RI→wide-band CQI for first TB→sub-band differential CQI for first TB.

TABLE 8
Mapping order of CSI fields of one CSI report,
CSI part 1 reportQuantity set to ‘cri-RI-CQI’
and cqi-FormatIndicator = subbandCQI

| CSI report | |
|---|---|
| number | CSI fields |
| CSI report | CRI, if reported |
| #n | Rank Indicator, if reported |
| CSI part 1 | Wide-band CQI for the first TB, if reported |
| | Sub-band differential CQI for the first TB with increasing |
| | order of sub-band number, if reported |

In Table 8, sub-bands for given CSI report n indicated by the higher layer parameter “csi-ReportingBand” are numbered continuously in the increasing order with the lowest sub-band of “csi-ReportingBand” as sub-band 0.

The mapping order in CSI part 2 is: wide-band terms→sub-band terms. Referring to Table 9 below, for example, the mapping order of wide-band terms is: wide-band CQI for second TB (if rank>4)→LI.

TABLE 9
Mapping order of CSI fields of one CSI report,
CSI part 2 wide-band reportQuantity set to ‘cri-
RI-CQI’ and cqi-FormatIndicator = subbandCQI

| CSI report | |
|---|---|
| number | CSI fields |
| CSI report | Wide-band CQI for the second TB, if present and reported |
| #n | Layer Indicator, if reported |
| CSI part 2 | |
| wide-band | |

Referring to Table 10 below, for example, the mapping order of sub-band terms is: even sub-band terms→odd sub-band terms. The mapping order in each even and odd term is: sub-band CQI for second TB (if rank>4 and cqi is “cqi-FormatIndicator=subbandCQI”).

TABLE 10
Mapping order of CSI fields of one CSI report, CSI part
2 sub-band reportQuantity set to ‘cri-RI-CQI’ and
cqi-FormatIndicator = subbandCQI

| | |
|---|---|
| CSI report | Sub-band differential CQI for the second TB of all even |
| #n | sub-bands with increasing order of sub-band number, |
| Part 2 | if cqi-FormatIndicator = subbandCQI and if reported |
| sub-band | Sub-band differential CQI for the second TB of all odd |
| | sub-bands with increasing order of sub-band number, |
| | if cqi-FormatIndicator = subbandCQI and if reported |

In Table 10, sub-bands for given CSI report n indicated by the higher layer parameter “csi-ReportingBand” are numbered continuously in the increasing order with the lowest sub-band of “csi-ReportingBand” as sub-band 0.

Alternatively, in an aspect, for UCI on PUCCH with sub-band CQI and for UCI on PUSCH with sub-band/wide-band CSI, the mapping order in Table 6 above for codebook-based CSI for sub-band CSI (e.g., when either or both of “pmi-FormatIndicator=subbandPMI” and “cqi-FormatIndicator=subbandCQI”) may also be used for non-PMI-based CSI (e.g., reportQuantity set to “cri-RI-CQI” and cqi-FormatIndicator=subbandCQI), except that PMI reporting fields: PMI X1 and PMI X2 are omitted for non-PMI-based CSI.

In an aspect, for CSI reporting with non-PMI-based CSI (report quantity=“cri-ri-cqi”), the UE may expect the higher layer parameter “pmi-FormatIndicator” to be set to “widebandPMI.” Alternatively, the UE may expect that the higher layer parameter “pmi-FormatIndicator” is not configured. Alternatively, the UE may ignore the higher layer parameter “pmi-FormatIndicator.”

In an aspect, for CSI reporting with non-PMI based CSI (report quantity=“cri-ri-cqi”), the UE may expect that the higher layer parameter “codebookConfig” or “codebookConfig-r16” are not configured. Alternatively, the UE may ignore the higher layer parameter “codebookConfig” or “codebookConfig-r16.”

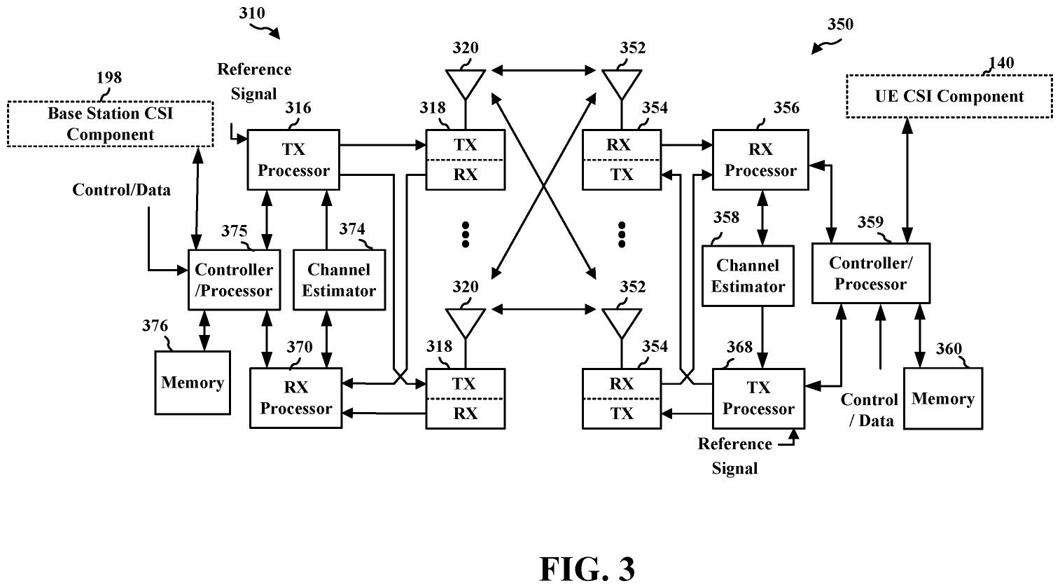

FIG. 3 is a block diagram of a base station 310 including a base station CSI component 198 in communication with a UE 350 including a UE CSI component 140 in an access network, where the base station 310 may be an example implementation of base station 102 and where UE 350 may be an example implementation of UE 104. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE CSI component 140 of FIG. 1.

At least one of the TX processor 316, the RX processor 370, and the controller/processor 375 may be configured to perform aspects in connection with the base station CSI component 198 of FIG. 1.

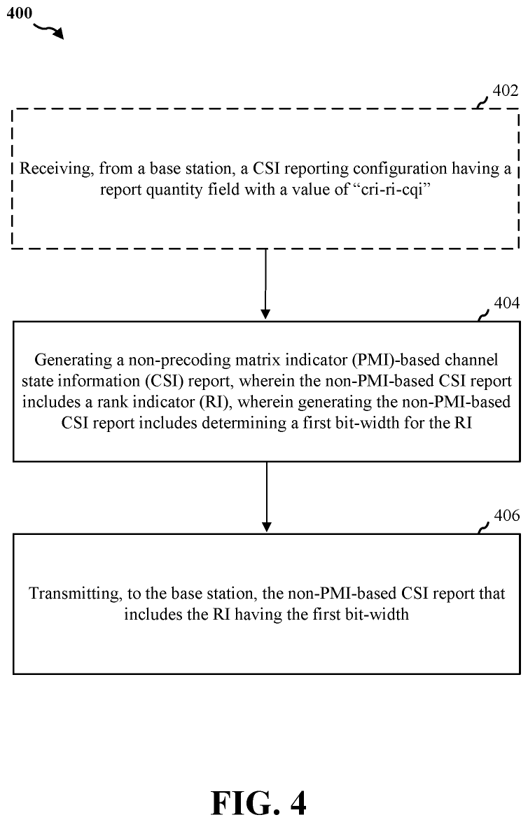

FIG. 4 is a flowchart of a method 400 of wireless communication by a UE. In an aspect, the method 400 may be performed by a wireless communication device, such as the UE 104 or 350, which may include the memory 360 and which may be the entire UE 104 or 350 or a component of the UE 104 or 350 such as the UE CSI component 140, the TX processor 368, the RX processor 356, and/or the controller/processor 359.

The below description of method 400 begins with optional block 402 and continues with blocks 404 and 406.

In an optional aspect, at 402, the method 400 may include receiving, from a base station, a CSI reporting configuration having a report quantity field with a value of “cri-ri-cqi.” For example, in an aspect, the UE 104 or 350, the UE CSI component 140, the TX processor 368, the RX processor 356, and/or the controller/processor 359 may receive, from the base station, a CSI reporting configuration having a report quantity field with a value of “cri-ri-cqi.” Accordingly, in an aspect, the UE 104 or 350, the UE CSI component 140, the TX processor 368, the RX processor 356, and/or the controller/processor 359 may provide means for receiving, from the base station, a CSI reporting configuration having a report quantity field with a value of “cri-ri-cqi.”

For example, referring to FIG. 1, in an aspect, the UE CSI component 140 of the UE 104 may receive, from the base station CSI component 198 of the base station 102, the CSI reporting configuration 101 having the report quantity field 189 with a value of “cri-ri-cqi” 199. Accordingly, the base station 102 may send the CSI reporting configuration 101 having the report quantity field 189 with the value of “cri-ri-cqi” 199 in order to configure the UE 104 for reporting the non-PMI-based CSI 141.

At 404, the method 400 includes generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI. For example, in an aspect, the UE 104 or 350, the UE CSI component 140, the TX processor 368, the RX processor 356, and/or the controller/processor 359 may generate a non-precoding matrix indicator (PMI)-based channel state information (CSI) report, wherein the non-PMI-based CSI report includes a rank indicator (RI), wherein generating the non-PMI-based CSI report includes determining a first bit-width for the RI. Accordingly, in an aspect, the UE 104 or 350, the UE CSI component 140, the TX processor 368, the RX processor 356, and/or the controller/processor 359 may provide means for generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI.

For example, referring to FIG. 1, in an aspect, the UE CSI component 140 of the UE 104 may generate the non-PMI-based CSI 141, where the non-PMI-based CSI 141 includes the RI with the first bit-width 142. In order to generate the non-PMI-based CSI 141, the UE CSI component 140 of the UE 104 may determine the first bit-width, for example, as described below with reference to various aspects.

In one optional aspect, generating the non-PMI-based CSI report at block 404 comprises generating the non-PMI-based CSI report responsive to the report quantity field having the value of “cri-ri-cqi,” as received in block 402 from the base station 102.

At 406, the method 400 includes transmitting, to a base station, the non-PMI-based CSI report that includes the RI having the first bit-width. For example, in an aspect, the UE 104 or 350, the UE CSI component 140, the TX processor 368, the RX processor 356, and/or the controller/processor 359 may transmit, to a base station, the non-PMI-based CSI report that includes the RI having the first bit-width. Accordingly, in an aspect, the UE 104 or 350, the UE CSI component 140, the TX processor 368, the RX processor 356, and/or the controller/processor 359 may provide means for transmitting, to a base station, the non-PMI-based CSI report that includes the RI having the first bit-width.

For example, referring to FIG. 1, in an aspect, the UE 104 may transmit, to the base station 102, the non-PMI-based CSI 141 that includes the RI with the first bit-width 142.

In one optional aspect, generating the non-PMI-based CSI report at block 404 comprises determining the first bit-width of the RI by calculating the first bit-width as a function of a number of allowable ranks or rank pairs. In an optional aspect, RI codepoints map to ranks in increasing order with codepoint zero mapped to a lowest rank per resource. For example, for CSI reporting with non-PMI-based CSI (report quantity=“cri-ri-cqi”), RI may be reported using a bit-width that depends on the number of allowable ranks or rank pairs (e.g., for mTRP NCJT CSI), and the values of the RI field are mapped to allowed RI values with increasing order, where “0” is mapped to the smallest allowed RI value. In an aspect, for example, the bit-width for RI is ┌log₂ n_{RI}┐ or min (┌log₂ P┐, ┌log₂ N_{RI}┐) bits, where n_{RI} is the number of allowable ranks corresponding to the configured fields of “PortIndexFor8Ranks,” if configured. If not configured, the number of allowable ranks equals the number of total ports per resource. For example, if only port sequences for rank 1 and rank 3 are provided, then one bit is used, where codepoint “0” corresponds to rank 1, and codepoint “1” corresponds to rank 3.

In one optional aspect, generating the non-PMI-based CSI report at block 404 comprises calculating the first bit-width as a function of a total number of different allowable ranks across all resources. In one optional aspect, RI codepoints map to allowable ranks across all resources in increasing order with codepoint zero mapped to a lowest rank across all resources. For example, in an aspect, the bit-width of RI may be dependent on the total number of different allowable ranks across all resources associated with the non-PMI based CSI report configuration, and the codepoints may be mapped to the allowable ranks across all CSI-RS resources in increasing order, with codepoint 0 mapped to the smallest allowable rank across all resources. For example, if there are a total of two resources, where resource 1 is configured with allowable ranks 2 and 3, and resource 2 is configured with allowable ranks 2, 4, and 6, then RI may be reported using 2 bits because the different allowable ranks are {2, 3, 4, 6} and the total number of different allowable ranks is 4. The codepoints may be mapped to ranks in increasing order, with codepoint “00” mapped to rank 2. If resource 1 is selected, the UE is expected to report codepoints “00” or “01”, and if resource 2 is selected, the UE is expected to report codepoints “00”, “10”, or “11”.

In an optional aspect, determining the first bit-width of the RI comprises calculating the first bit-width as a function of a maximum number of allowable ranks across all resources. For example, in some aspects, the fields “PortIndexFor8Ranks” are different for different CSI-RS resources, and the bit-width for RI is ┌log₂ N_{RI}┐ or min (┌log₂ P┐, ┐log₂ N_{RI}┐) bits, where n_{RI} is the maximum number of allowable ranks across all the CSI-RS resources associated with the CSI report configuration corresponding to the configured fields of “PortIndexFor8Ranks” for each CSI-RS resource, if configured. For example, in one non-limiting aspect, if for CSI-RS resource 1, only port sequences for rank 1 and rank 3 are provided, while for CSI-RS resource 2, port sequences for rank 1-4 are provided, then 2 bits are used for reporting RI.

In an optional aspect, RI codepoints map to ranks in increasing order with codepoint zero mapped to a lowest rank of a resource reported via a CSI-RS resource indicator (CRI). For example, in some aspects, the codepoint mapping may depend on the reported resource, and each codepoint provided by the RI indicator maps to the allowable rank in the selected CSI-RS resource in increasing order, with codepoint “0” mapped to the lowest rank of the selected resource. For example, in one non-limiting aspect, if for CSI-RS resource 1, only port sequences for rank 1 and rank 3 are provided, while for CSI-RS resource 2, port sequences for rank 1-4 are provided, and if the UE selects CSI-RS resource 1 and reports the selection by CRI, then codepoint “00” in RI corresponds to rank 1, codepoint “01” corresponds to rank 3, and the UE does not expect to report codepoint “10” and “11.” Alternatively, if the UE selects CSI-RS resource 2 and reports the selection by CRI, then codepoint “00” in RI corresponds to rank 1, codepoint “01” corresponds to rank 2, codepoint “10” corresponds to rank 3, and codepoint “11” corresponds to rank 4.

In an optional aspect, determining the first bit-width of the RI comprises calculating the first bit-width as a function of a maximum allowable rank across all resources and a minimum allowable rank across all resources. In an optional aspect, RI codepoints map to allowable ranks across all resources in increasing order with codepoint zero mapped to a lowest rank across all resources. For example, in an aspect, the bit-width of the RI may be based on the difference between the maximum and minimum allowable rank across all resources associated with the non-PMI-based CSI report configuration, and the codepoints may be mapped to the allowable ranks configured for the indicated CSI-RS resources in increasing order, with codepoint 0 mapped to the smallest allowable rank across all resources. In an optional aspect, determining the first bit-width of the RI comprises calculating the first bit-width based on a difference between the maximum allowable rank across all resources and the minimum allowable rank across all resources. For example, if there are a total of two resources, where resource 1 is configured with allowable ranks 2 and 3, and resource 2 is configured with allowable ranks 2, 4, and 6, then RI may be reported using 3 bits because n_{RI}=6-2+1=5. The codepoints may be mapped to ranks in increasing order, with codepoint “000” mapped to rank 2. If resource 1 is selected, the UE is expected to report codepoints “000” or “001”, and if resource 2 is selected, the UE is expected to report codepoints “000”, “010”, or “100”.

In one optional aspect, generating the non-PMI-based CSI report at block 404 comprises determining the first bit-width of the RI by calculating the first bit-width as a function of a maximum allowable rank or rank pair. In an optional aspect, RI codepoints map to ranks in increasing order with codepoint zero mapped to rank 1. In another optional aspect, generating the non-PMI-based CSI report at block 404 comprises determining the first bit-width of the RI by calculating the first bit-width as a function of a number of ports per CSI-reference signal (CSI-RS) resource. For example, for CSI reporting with non-PMI-based CSI (report quantity=“cri-ri-cqi”), RI may be reported using a bit-width that depends on the maximum allowable rank or rank pair (e.g., for mTRP NCJT CSI) or the number of total ports per CSI-RS resource, and only the codepoints corresponding to the allowable ranks are valid. In an aspect, for example, the bit-width for RI is ┌log₂ n_{RI,max}┐ or ┌log₂ nPorts┐ bits, where n_{RI,max} is the maximum allowable rank corresponding to the configured fields of “PortIndexFor8Ranks,” if configured. If not configured, the number of allowable ranks equals the number of total ports per resource. Also, the values of the RI field are mapped with increasing order, where “0” is mapped to rank 1. For example, if only port sequences for rank 1 and rank 3 are provided, then two bits are used, where codepoint “00” corresponds to rank 1, codepoint “01” corresponds to rank 2, and codepoint “10” corresponds to rank 3. However, only codepoint “00” and “10” may be reported.

In one optional aspect, determining the first bit-width of the RI comprises calculating the first bit-width as a function of a maximum allowable rank across all resources. In one optional aspect, RI codepoints map to ranks in increasing order with codepoint zero mapped to rank 1 and a highest codepoint mapped to the maximum allowable rank across all resources. For example, in an aspect, “PortIndexFor8Ranks” may be different for each resource. In this case, for example, for CSI reporting with non-PMI-based CSI (report quantity=“cri-ri-cqi”), RI is reported using a bit-width that depends on the maximum allowable rank or rank pair (e.g., for mTRP NCJT CSI) or the number of total ports across all CSI-RS resources associated with the CSI report configuration, and only the codepoints corresponding to the allowable ranks are valid. In some aspects, the codepoint mapping does not depend on the reported resource, but the valid codepoints depend on the reported resource. For example, if for CSI-RS resource 1, port sequences for rank 1 and 3 are provided, while for CSI-RS resource 2, port sequences for rank 2 and 4 are provided, then there are 2 bits used to indicate RI, with codepoint “00” corresponding to rank 1, codepoint “01” corresponding to rank 2, codepoint “10” corresponding to rank 3, and codepoint “11” corresponding to rank 4. However, if the UE selects CSI-RS resource 1, only codepoint “00” and “10” may be reported, and if the UE selects CSI-RS resource 2, only codepoint “01” and “11” may be reported. In an alternative non-limiting aspect, RI is reported using a bit-width that depends on the maximum rank associated with the CSI report configuration, and only the codepoints corresponding to the allowable ranks are valid. The codepoint maps to rank in increasing order, with codepoint “000” mapped to rank 1. In an aspect, for example, RI is always reported using 3 bits because the maximum possible rank is 8, and if for a CSI-RS resource, port sequence is only provided for rank 1 and rank 3, then only codepoints “000” and “010” are valid.

In one optional implementation, the non-PMI-based CSI report further comprises a layer indicator (LI) having a second bit-width. For example, referring to FIG. 1, the UE CSI component 140 of the UE 104 may generate the non-PMI-CSI 141 including the LI with the second bit-width 143.

In one optional implementation, generating the non-PMI-based CSI report at block 404 further comprises calculating the second bit-width of the LI as a function of a reported value of rank. For example, the UE 104 may further report LI (e.g., which indicates the strongest layer) using a bit-width that depends on the reported value of rank, e.g., ┌log₂ ν┐ bits. The codepoint maps LI in increasing order, with codepoint “0” mapped to layer 0, codepoint “1” mapped to layer 1, etc.

In one optional implementation, generating the non-PMI-based CSI report at block 404 further comprises calculating the second bit-width of the LI as a function of a number of ports per CSI-RS resource. For example, the UE 104 may report LI using a bit-width that depends on the number of CSI-RS ports per resource, e.g., ┌log₂ nPorts┐ bits. Specifically, in an aspect, for non-PMI-based CSI reporting where each port corresponds to one layer (e.g., a PDSCH layer), selecting the strongest layer is the same as selecting the strongest point. The codepoint maps the port index in increasing order, with codepoint “0” mapped to port 0, which indicates that the layer conveyed by the indicated port is the strongest.

In one optional aspect, the non-PMI-based CSI report further comprises a CSI-RS resource indicator (CRI) having a third bit-width. For example, referring to FIG. 1, the UE CSI component 140 of the UE 104 may generate the non-PMI-CSI 141 including the CRI with the third bit-width 144.

In one optional aspect, generating the non-PMI-based CSI report at block 404 further comprises calculating the third bit-width of the CRI as a function of a number of CSI-RS resources. For example, the UE 104 may report CRI with a bit-width that depends on the number of CSI-RS resources.

In one optional aspect, for uplink control information (UCI) transmission on a physical uplink control channel (PUCCH) with wide-band CSI, a UCI packing order for the non-PMI-based CSI report comprises one part with a mapping order of: a CSI-RS resource indicator (CRI); the RI; zero-padding bits; and a wide-band channel quality indicator (CQI) for a first transport block. For example, in some non-limiting aspects, for UCI on PUCCH and wide-band CSI (e.g., wide-band CQI), UCI for non-PMI-based CSI may include one part with the following mapping order: CRI→RI→zero padding bits→wide-band CQI for first TB.

In one optional implementation, the mapping order further comprises a layer indicator (LI) located between the RI and the zero-padding bits. For example, in some non-limiting aspects, for UCI on PUCCH and wide-band CSI (e.g., wide-band CQI), UCI for non-PMI-based CSI may include one part with the following mapping order: CRI→RI→LI→zero padding bits→wide-band CQI for first TB.

In one optional aspect, the above mapping order comprises the LI only when the UE is configured by the base station to include the LI in the non-PMI-based CSI report.

In one optional aspect, the mapping order further comprises a wide-band CQI for a second transport block, wherein the wide-band CQI for the second transport block is located in the mapping order subsequent to the wide-band CQI for the first transport block. For example, referring to Table 7 above, for UCI on PUCCH and wide-band CSI (e.g., wide-band CQI), UCI for non-PMI-based CSI may include one part with the following mapping order: CRI→RI→LI (if LI is included)→zero padding bits→wide-band CQI for first TB→WB CQI for second TB.

In one optional aspect, the wide-band CQI for the second transport block is included in the above mapping order only for ranks greater than four.

In one optional aspect, for uplink control information (UCI) transmission on a physical uplink control channel (PUCCH) with wide-band CSI, a UCI packing order for the non-PMI-based CSI report comprises one part in which one or more PMI information fields are omitted. For example, in an aspect, the mapping order of Table 3 for codebook-based CSI (e.g., when “pmi-FormatIndicator-widebandPMI” and “cqi-FormatIndicator=widebandCQI”) may also be used for non-PMI-based CSI (e.g., when “reportQuantity” is set to “cri-RI-CQI” and “cqi-FormatIndicator=widebandCQI”) by omitting PMI reporting fields. For example, the codebook-based CSI mapping order: CRI→RI→LI→zero padding bits→PMI X1→PMI X2→wide-band CQI for first TB→wide-band CQI for second TB may be used for non-PMI-based CSI, except that PMI X1 and PMI X2 in Table 3 are not reported for non-PMI-based CSI.

In one optional aspect, for uplink control information (UCI) transmission on a physical uplink control channel (PUCCH) with wide-band CSI, a UCI packing order for the non-PMI-based CSI report comprises one part with a number of zero padding bits, wherein the zero padding bits keep a total payload size invariant. For example, referring to Table 7 above, for UCI on PUCCH and wide-band CSI (e.g., wide-band CQI), UCI for non-PMI-based CSI includes one part with the following mapping order: CRI→RI→LI (if LI is included)→zero padding bits→wide-band CQI for first TB→WB CQI for second TB. The number of zeros to be padded is zero for one CSI-RS port, and is O_{P}=Nₘₐₓ−N_{reported} for more than one CSI-RS ports, where Nₘₐₓ is the maximum possible payload size given the CSI report configuration, and N_{reported} is the reported payload size. In an aspect, for example, Nₘₐₓ is the maximum possible payload size over all possible rank values that are allowed to be reported, and N_{reported} is the reported payload size for the reported rank. In an aspect, for example, N_{reported} is the sum of the reported payload sizes for reporting each field of the CSI. For non-PMI-based CSI, the length of the PMI part of the CSI is zero, therefore O_{P} only depends on LI. In an aspect, for example, the reported payload size is a function of the LI payload size: N_{LI}(r), where N_{LI}(r)=ceil (log 2(r)), where r is the reported rank value.

In one optional aspect, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts.

In one optional aspect, a first payload size of a first part of the non-PMI-based CSI report is invariant; and a second payload size of a second part of the non-PMI-based CSI report depends on one or more values reported in the first part of the non-PMI-based CSI report.

In one optional aspect, a first part of the non-PMI-based CSI report has a mapping order of: a CSI-RS resource indicator (CRI); the RI; a wide-band channel quality indicator (CQI) for a first transport block; and a sub-band differential CQI for the first transport block. For example, referring to Table 8 above, the mapping order in CSI part 1 is: CRI→RI→wide-band CQI for first TB→sub-band differential CQI for first TB.

In one optional aspect, a second part of the non-PMI-based CSI report has a mapping order of: one or more wide-band terms; and one or more sub-band terms. For example, in an aspect, the mapping order in CSI part 2 is: wide-band terms→sub-band terms.

In one optional aspect, the one or more wide-band terms comprise: a wide-band CQI for a second transport block, wherein the wide-band CQI for the second transport block is included in the mapping order only for ranks greater than four; and a layer indicator (LI). For example, referring to Table 9 above, the mapping order of wide-band terms is: wide-band CQI for second TB (if rank>4)→LI.

In one optional aspect, the one or more sub-band terms comprise: one or more even sub-band terms; and one or more odd sub-band terms. For example, referring to Table 10 above, the mapping order of sub-band terms is: even sub-band terms→odd sub-band terms.

In one optional aspect, each one of the one or more even sub-band terms and the one or more odd sub-band terms comprises a sub-band CQI for a second transport block. For example, referring to Table 10 above, the mapping order in each even and odd term is: sub-band CQI for second TB (if rank>4 and cqi is “cqi-FormatIndicator=subbandCQI”).

In one optional aspect, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts in which one or more PMI fields are omitted. For example, in an aspect, for UCI on PUCCH with sub-band CQI and for UCI on PUSCH with sub-band/wide-band CSI, the mapping order in Table 6 above for codebook-based CSI for sub-band CSI (e.g., when either or both b of “pmi-FormatIndicator-subbandPMI” and “cqi-FormatIndicator=subbandCQI”) may also be used for non-PMI-based CSI (e.g., reportQuantity set to “cri-RI-CQI” and cqi-FormatIndicator-subbandCQI), except that PMI reporting fields: PMI X1 and PMI X2 are omitted for non-PMI-based CSI.

In one optional aspect, generating the non-PMI-based CSI report at block 404 is responsive to the base station refraining from configuring the UE with a “pmi-FormatIndicator” parameter, or the base station configuring the UE with the “pmi-FormatIndicator” parameter set to “widebandPMI,” or the UE ignoring the “pmi-FormatIndicator” parameter. For example, for CSI reporting with non-PMI-based CSI (report quantity=“cri-ri-cqi”), the UE may expect the higher layer parameter “pmi-FormatIndicator” to be set to “widebandPMI.” Alternatively, the UE may expect that the higher layer parameter “pmi-FormatIndicator” is not configured. Alternatively, the UE may ignore the higher layer parameter “pmi-FormatIndicator.”

In one optional aspect, generating the non-PMI-based CSI report at block 404 is responsive to the base station refraining from configuring the UE with a “codebookConfig” or “codebookConfig-r16” parameter, or the UE ignoring the “codebookConfig” or “codebookConfig-r16” parameter. For example, for CSI reporting with non-PMI based CSI (report quantity=“cri-ri-cqi”), the UE may expect that the higher layer parameter “codebookConfig” or “codebookConfig-r16” are not configured. Alternatively, the UE may ignore the higher layer parameter “codebookConfig” or “codebookConfig-r16.”

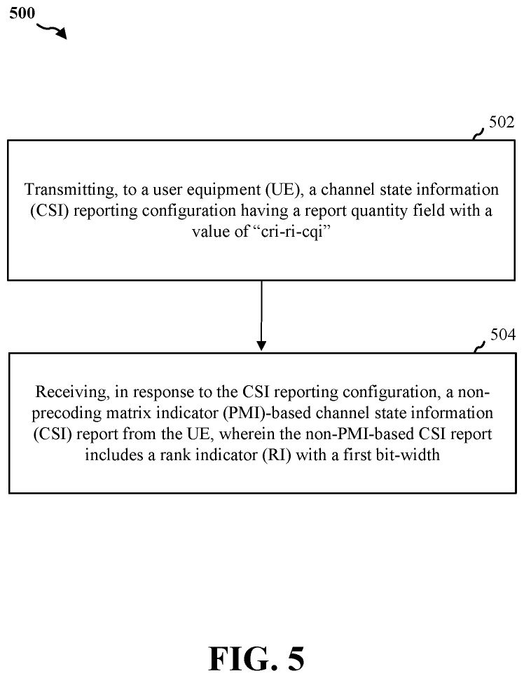

FIG. 5 is a flowchart of a method 500 of wireless communication by a base station. In an aspect, the method 500 may be performed by a wireless communication device, such as the base station 102 or 310, which may include the memory 376 and which may be the entire base station 102 or 310 or a component of the base station 102 or 310 such as the base station CSI component 198, the TX processor 316, the RX processor 370, and/or the controller/processor 375.

At 502, the method 500 includes transmitting, to a user equipment (UE), a channel state information (CSI) reporting configuration having a report quantity field with a value of “cri-ri-cqi.” For example, in an aspect, the base station 102 or 310, the base station CSI component 198, the TX processor 316, the RX processor 370, and/or the controller/processor 375 may transmit, to a user equipment (UE), a channel state information (CSI) reporting configuration having a report quantity field with a value of “cri-ri-cqi.” Accordingly, in an aspect, the base station 102 or 310, the base station CSI component 198, the TX processor 316, the RX processor 370, and/or the controller/processor 375 may provide means for transmitting, to a user equipment (UE), a channel state information (CSI) reporting configuration having a report quantity field with a value of “cri-ri-cqi.”

For example, referring to FIG. 1, in an aspect, the base station 102 may send the CSI reporting configuration 101 having the report quantity field 189 with the value of “cri-ri-cqi” 199 in order to configure the UE 104 for reporting the non-PMI-based CSI 141.

At 504, the method 500 includes receiving, in response to the CSI reporting configuration, a non-precoding matrix indicator (PMI)-based channel state information (CSI) report from the UE, wherein the non-PMI-based CSI report includes a rank indicator (RI) with a first bit-width. For example, in an aspect, the base station 102 or 310, the base station CSI component 198, the TX processor 316, the RX processor 370, and/or the controller/processor 375 may receive, in response to the CSI reporting configuration, a non-precoding matrix indicator (PMI)-based channel state information (CSI) report from the UE, wherein the non-PMI-based CSI report includes a rank indicator (RI) with a first bit-width. Accordingly, in an aspect, the base station 102 or 310, the base station CSI component 198, the TX processor 316, the RX processor 370, and/or the controller/processor 375 may provide means for receiving, in response to the CSI reporting configuration, a non-precoding matrix indicator (PMI)-based channel state information (CSI) report from the UE, wherein the non-PMI-based CSI report includes a rank indicator (RI) with a first bit-width.

For example, referring to FIG. 1, in an aspect, the base station 102 may receive, from the UE 104, the non-PMI-based CSI 141 that includes the RI with the first bit-width 142.

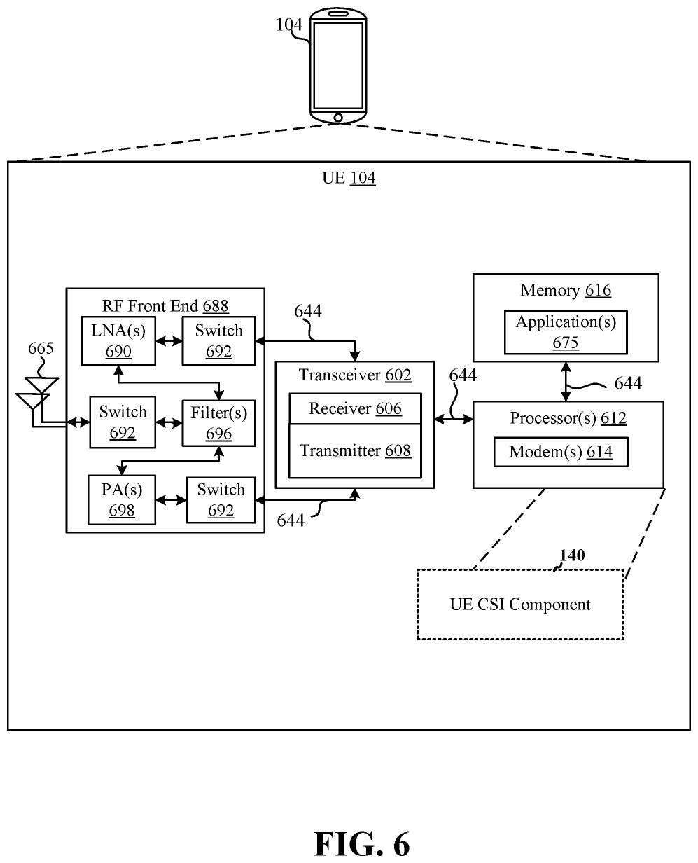

Referring to FIG. 6, one example of an implementation of UE 104 may include a variety of components, some of which have already been described above, but including components such as one or more processors 612 and memory 616 and transceiver 602 in communication via one or more buses 644, which may operate in conjunction with modem 614, and UE CSI component 140 to enable one or more of the functions described herein related to CSI reporting. Further, the one or more processors 612, modem 614, memory 616, transceiver 602, RF front end 688 and one or more antennas 665 may be configured to support voice and/or data calls (simultaneously or non-simultaneously) in one or more radio access technologies. The antennas 665 may include one or more antennas, antenna elements, and/or antenna arrays.

In an aspect, the one or more processors 612 may include a modem 614 that uses one or more modem processors. The various functions related to UE CSI component 140 may be included in modem 614 and/or processors 612 and, in an aspect, may be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with UE CSI component 140 may be performed by transceiver 602.

Also, memory 616 may be configured to store data used herein and/or local versions of applications 675, UE CSI component 140 and/or one or more of subcomponents thereof being executed by at least one processor 612. Memory 616 may include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining UE CSI component 140 and/or one or more of subcomponents thereof, and/or data associated therewith, when UE 104 is operating at least one processor 612 to execute UE CSI component 140 and/or one or more subcomponents thereof.

Transceiver 602 may include at least one receiver 606 and at least one transmitter 608. Receiver 606 may include hardware, firmware, and/or software code executable by a processor for receiving data, the code including instructions and being stored in a memory (e.g., computer-readable medium). Receiver 606 may be, for example, a radio frequency (RF) receiver. In an aspect, receiver 606 may receive signals transmitted by at least one base station 102. Additionally, receiver 606 may process such received signals, and also may obtain measurements of the signals, such as, but not limited to, Ec/Io, signal-to-noise ratio (SNR), reference signal received power (RSRP), received signal strength indicator (RSSI), etc. Transmitter 608 may include hardware, firmware, and/or software code executable by a processor for transmitting data, the code including instructions and being stored in a memory (e.g., computer-readable medium). A suitable example of transmitter 808 may including, but is not limited to, an RF transmitter.

Moreover, in an aspect, UE 104 may include RF front end 688, which may operate in communication with one or more antennas 665 and transceiver 602 for receiving and transmitting radio transmissions, for example, wireless communications transmitted by at least one base station 102 or wireless transmissions transmitted by UE 104. RF front end 688 may be connected to one or more antennas 665 and may include one or more low-noise amplifiers (LNAs) 690, one or more switches 692, one or more power amplifiers (PAS) 698, and one or more filters 696 for transmitting and receiving RF signals.

In an aspect, LNA 690 may amplify a received signal at a desired output level. In an aspect, each LNA 690 may have a specified minimum and maximum gain values. In an aspect, RF front end 688 may use one or more switches 692 to select a particular LNA 690 and its specified gain value based on a desired gain value for a particular application.

Further, for example, one or more PA(s) 698 may be used by RF front end 688 to amplify a signal for an RF output at a desired output power level. In an aspect, each PA 698 may have specified minimum and maximum gain values. In an aspect, RF front end 688 may use one or more switches 692 to select a particular PA 698 and its specified gain value based on a desired gain value for a particular application.

Also, for example, one or more filters 696 may be used by RF front end 688 to filter a received signal to obtain an input RF signal. Similarly, in an aspect, for example, a respective filter 696 may be used to filter an output from a respective PA 698 to produce an output signal for transmission. In an aspect, each filter 696 may be connected to a specific LNA 690 and/or PA 698. In an aspect, RF front end 688 may use one or more switches 692 to select a transmit or receive path using a specified filter 696, LNA 690, and/or PA 698, based on a configuration as specified by transceiver 602 and/or processor 612.

As such, transceiver 602 may be configured to transmit and receive wireless signals through one or more antennas 665 via RF front end 688. In an aspect, transceiver 602 may be tuned to operate at specified frequencies such that UE 104 can communicate with, for example, one or more base stations 102 or one or more cells associated with one or more base stations 102. In an aspect, for example, modem 614 may configure transceiver 602 to operate at a specified frequency and power level based on the UE configuration of the UE 104 and the communication protocol used by modem 614.

In an aspect, modem 614 may be a multiband-multimode modem, which can process digital data and communicate with transceiver 602 such that the digital data is sent and received using transceiver 602. In an aspect, modem 614 may be multiband and be configured to support multiple frequency bands for a specific communications protocol. In an aspect, modem 614 may be multimode and be configured to support multiple operating networks and communications protocols. In an aspect, modem 614 may control one or more components of UE 104 (e.g., RF front end 688, transceiver 602) to enable transmission and/or reception of signals from the network based on a specified modem configuration. In an aspect, the modem configuration may be based on the mode of the modem and the frequency band in use. In another aspect, the modem configuration may be based on UE configuration information associated with UE 104 as provided by the network during cell selection and/or cell reselection.

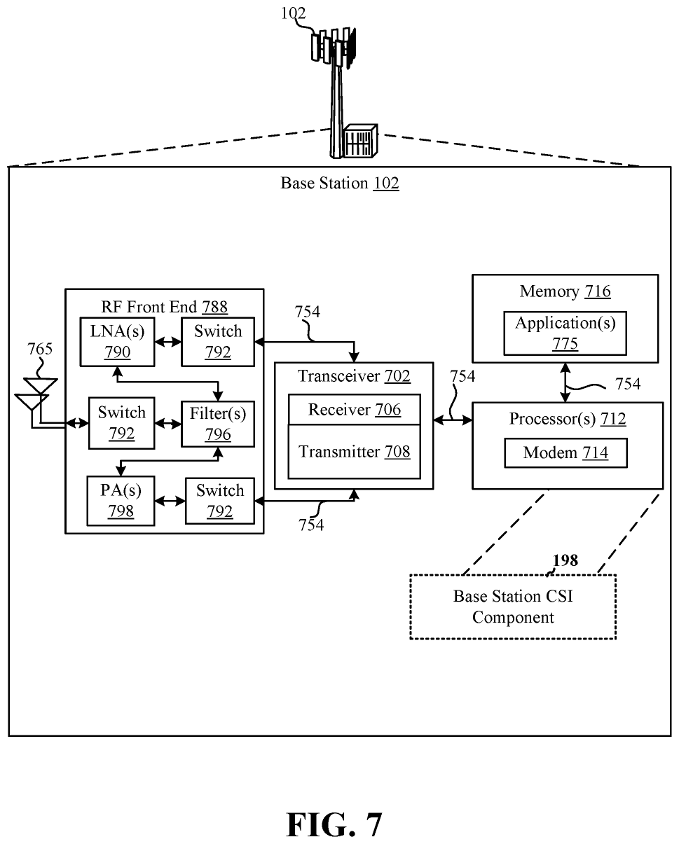

Referring to FIG. 7, one example of an implementation of base station 102 may include a variety of components, some of which have already been described above, but including components such as one or more processors 712 and memory 716 and transceiver 702 in communication via one or more buses 754, which may operate in conjunction with modem 714 and base station CSI component 198 to enable one or more of the functions described herein related to CSI reporting.

The transceiver 702, receiver 706, transmitter 708, one or more processors 712, memory 716, applications 775, buses 754, RF front end 788, LNAs 790, switches 792, filters 796, PAs 798, and one or more antennas 765 may be the same as or similar to the corresponding components of UE 104, as described above, but configured or otherwise programmed for base station operations as opposed to UE operations.

Some further aspects are provided below.

1. A method of wireless communication by a user equipment (UE), comprising:
generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI; and
transmitting, to a base station, the non-PMI-based CSI report that includes the RI having the first bit-width.

2. The method of aspect 1, further comprising:
receiving, from the base station, a CSI reporting configuration having a report quantity field with a value of “cri-ri-cqi;” and
wherein generating the non-PMI-based CSI report comprises generating the non-PMI-based CSI report responsive to the report quantity field having the value of “cri-ri-cqi.”

3. The method of any of aspects 1-2, wherein determining the first bit-width of the RI comprises calculating the first bit-width as a function of a number of allowable ranks or rank pairs.

4. The method of aspect 3, wherein RI codepoints map to ranks in increasing order with codepoint zero mapped to a lowest rank per resource.

5. The method of any of aspects 1-2, wherein determining the first bit-width of the RI comprises calculating the first bit-width as a function of a total number of different allowable ranks across all resources.

6. the method of aspect 5, wherein RI codepoints map to allowable ranks across all resources in increasing order with codepoint zero mapped to a lowest rank across all resources.

7. The method of any of aspects 1-2, wherein determining the first bit-width of the RI comprises calculating the first bit-width as a function of a maximum number of allowable ranks across all resources.

8. The method of aspect 7, wherein RI codepoints map to ranks in increasing order with codepoint zero mapped to a lowest rank of a resource reported via a CSI-RS resource indicator (CRI).

9. The method of any of aspects 1-2, wherein determining the first bit-width of the RI comprises calculating the first bit-width as a function of a maximum allowable rank across all resources and a minimum allowable rank across all resources.

10. The method of aspect 9, wherein RI codepoints map to allowable ranks across all resources in increasing order with codepoint zero mapped to a lowest rank across all resources.

11. The method of aspect 9, wherein determining the first bit-width of the RI comprises calculating the first bit-width based on a difference between the maximum allowable rank across all resources and the minimum allowable rank across all resources.

12. The method of any of aspects 1-2, wherein determining the first bit-width of the RI comprises calculating the first bit-width as a function of a maximum allowable rank or rank pair.

13. The method of aspect 12, wherein RI codepoints map to ranks in increasing order with codepoint zero mapped to rank 1.

14. The method of any of aspects 1-2, wherein determining the first bit-width of the RI comprises calculating the first bit-width as a function of a maximum allowable rank across all resources.

15. The method of aspect 14, wherein RI codepoints map to ranks in increasing order with codepoint zero mapped to rank 1 and a highest codepoint mapped to the maximum allowable rank across all resources.

16. The method of any of aspects 1-2, wherein determining the first bit-width of the RI comprises calculating the first bit-width as a function of a number of ports per CSI-reference signal (CSI-RS) resource.

17. The method of any of aspects 1-2, wherein the non-PMI-based CSI report further comprises a layer indicator (LI) having a second bit-width, wherein generating the non-PMI-based CSI report further comprises calculating the second bit-width of the LI as a function of a reported value of rank or a number of ports per CSI-RS resource.

18. The method of any of aspects 1-2, wherein the non-PMI-based CSI report further comprises a CSI-RS resource indicator (CRI) having a third bit-width, wherein generating the non-PMI-based CSI report further comprises calculating the third bit-width of the CRI as a function of a number of CSI-RS resources.

19. The method of any of aspects 1-2, wherein, for uplink control information (UCI) transmission on a physical uplink control channel (PUCCH) with wide-band CSI, a UCI packing order for the non-PMI-based CSI report comprises one part with a mapping order of:
a CSI-RS resource indicator (CRI);
the RI;
zero-padding bits; and
a wide-band channel quality indicator (CQI) for a first transport block.

20. The method of aspect 19, wherein the mapping order further comprises a layer indicator (LI) located between the RI and the zero-padding bits.

21. The method of aspect 20, wherein the mapping order comprises the LI only when the UE is configured by the base station to include the LI in the non-PMI-based CSI report.

22. The method of aspect 19, wherein the mapping order further comprises a wide-band CQI for a second transport block, wherein the wide-band CQI for the second transport block is located in the mapping order subsequent to the wide-band CQI for the first transport block.

23. The method of aspect 22, wherein the wide-band CQI for the second transport block is included in the mapping order only for ranks greater than four.

24. The method of any of aspects 1-2, wherein, for uplink control information (UCI) transmission on a physical uplink control channel (PUCCH) with wide-band CSI, a UCI packing order for the non-PMI-based CSI report comprises one part in which one or more PMI information fields are omitted.

25. The method of any of aspects 1-2, wherein, for uplink control information (UCI) transmission on a physical uplink control channel (PUCCH) with wide-band CSI, a UCI packing order for the non-PMI-based CSI report comprises one part with a number of zero padding bits, wherein the zero padding bits keep a total payload size invariant.

26. The method of any of aspects 1-2,
wherein, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts;
wherein a first payload size of a first part of the non-PMI-based CSI report is invariant; and
wherein a second payload size of a second part of the non-PMI-based CSI report depends on one or more values reported in the first part of the non-PMI-based CSI report.

27. The method of aspect 26, wherein the first part of the non-PMI-based CSI report has a mapping order of:
a CSI-RS resource indicator (CRI);
the RI;
a wide-band channel quality indicator (CQI) for a first transport block; and
a sub-band differential CQI for the first transport block.

28. The method of aspect 26, wherein the second part of the non-PMI-based CSI report has a mapping order of:
one or more wide-band terms; and
one or more sub-band terms.

29. The method of aspect 28,
wherein the one or more wide-band terms comprise:
a wide-band CQI for a second transport block, wherein the wide-band CQI for the second transport block is included in the mapping order only for ranks greater than four; and
a layer indicator (LI),
wherein the one or more sub-band terms comprise:
one or more even sub-band terms; and
one or more odd sub-band terms,
wherein each one of the one or more even sub-band terms and the one or more odd sub-band terms comprises a sub-band CQI for the second transport block.

30. The method of any of aspects 1-2, wherein, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts in which one or more PMI fields are omitted.

31. The method of any of aspects 1-2, wherein generating the non-PMI-based CSI report is responsive to the base station refraining from configuring the UE with a “pmi-FormatIndicator” parameter, or the base station configuring the UE with the “pmi-FormatIndicator” parameter set to “widebandPMI,” or the UE ignoring the “pmi-FormatIndicator” parameter.

32. The method of any of aspects 1-2, wherein generating the non-PMI-based CSI report is responsive to the base station refraining from configuring the UE with a “codebookConfig” or “codebookConfig-r16” parameter, or the UE ignoring the “codebookConfig” or “codebookConfig-r16” parameter.

33. An apparatus for wireless communication by a user equipment (UE), comprising:
a memory; and
at least one processor coupled with the memory and configured to perform the method of any one of aspects 1-32.

33-1. An apparatus for wireless communication by a user equipment (UE), comprising means for performing the method of any one of aspects 1-32.

33-2. A non-transitory computer-readable medium storing computer executable code that, when executed by a processor of a UE, causes the processor to perform the method of any one of aspects 1-32.

34. A method of wireless communication by a base station, comprising:
transmitting, to a user equipment (UE), a channel state information (CSI) reporting configuration having a report quantity field with a value of “cri-ri-cqi;” and
receiving, in response to the CSI reporting configuration, a non-precoding matrix indicator (PMI)-based channel state information (CSI) report from the UE, wherein the non-PMI-based CSI report includes a rank indicator (RI) with a first bit-width.

35. An apparatus for wireless communication by a base station, comprising:
a memory; and
at least one processor coupled with the memory and configured to perform the method of aspect 34.

35-1. An apparatus for wireless communication by a base station, comprising means for performing the method of aspect 34.

35-2. A non-transitory computer-readable medium storing computer executable code that, when executed by a processor of a base station, causes the processor to perform the method of aspect 34.

Several aspects of telecommunication systems have been presented with reference to various apparatus and methods. These apparatus and methods have been described in the above detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a user equipment (UE), comprising:
generating a non-precoding matrix indicator (PMI)-based channel state information (CSI) report, wherein the non-PMI-based CSI report includes a rank indicator (RI), wherein generating the non-PMI-based CSI report includes determining a first bit-width for the RI; and
transmitting, to a base station, the non-PMI-based CSI report that includes the RI having the first bit-width.

2. The method of claim 1, further comprising:
receiving, from the base station, a CSI reporting configuration having a report quantity field with a value of “cri-ri-cqi;” and
wherein generating the non-PMI-based CSI report comprises generating the non-PMI-based CSI report responsive to the report quantity field having the value of “cri-ri-cqi.”

3. The method of claim 1, wherein determining the first bit-width of the RI comprises calculating the first bit-width as a function of a number of allowable ranks or rank pairs.

4. The method of claim 3, wherein RI codepoints map to ranks in increasing order with codepoint zero mapped to a lowest rank per resource.

5. The method of claim 1, wherein determining the first bit-width of the RI comprises calculating the first bit-width as a function of a total number of different allowable ranks across all resources.

6. The method of claim 5, wherein RI codepoints map to allowable ranks across all resources in increasing order with codepoint zero mapped to a lowest rank across all resources.

7. The method of claim 1, wherein determining the first bit-width of the RI comprises calculating the first bit-width as a function of a maximum number of allowable ranks across all resources.

8. The method of claim 7, wherein RI codepoints map to ranks in increasing order with codepoint zero mapped to a lowest rank of a resource reported via a CSI-RS resource indicator (CRI).

9. The method of claim 1, wherein determining the first bit-width of the RI comprises calculating the first bit-width as a function of a maximum allowable rank across all resources and a minimum allowable rank across all resources.

10. The method of claim 9, wherein RI codepoints map to allowable ranks across all resources in increasing order with codepoint zero mapped to a lowest rank across all resources.

11. The method of claim 9, wherein determining the first bit-width of the RI comprises calculating the first bit-width based on a difference between the maximum allowable rank across all resources and the minimum allowable rank across all resources.

12. The method of claim 1, wherein determining the first bit-width of the RI comprises calculating the first bit-width as a function of a maximum allowable rank or rank pair.

13. The method of claim 12, wherein RI codepoints map to ranks in increasing order with codepoint zero mapped to rank 1.

14. The method of claim 1, wherein determining the first bit-width of the RI comprises calculating the first bit-width as a function of a maximum allowable rank across all resources.

15. The method of claim 14, wherein RI codepoints map to ranks in increasing order with codepoint zero mapped to rank 1 and a highest codepoint mapped to the maximum allowable rank across all resources.

16. The method of claim 1, wherein determining the first bit-width of the RI comprises calculating the first bit-width as a function of a number of ports per CSI-reference signal (CSI-RS) resource.

17. The method of claim 1, wherein the non-PMI-based CSI report further comprises a layer indicator (LI) having a second bit-width, wherein generating the non-PMI-based CSI report further comprises calculating the second bit-width of the LI as a function of a reported value of rank or a number of ports per CSI-RS resource.

18. The method of claim 1, wherein the non-PMI-based CSI report further comprises a CSI-RS resource indicator (CRI) having a third bit-width, wherein generating the non-PMI-based CSI report further comprises calculating the third bit-width of the CRI as a function of a number of CSI-RS resources.

19. The method of claim 1, wherein, for uplink control information (UCI) transmission on a physical uplink control channel (PUCCH) with wide-band CSI, a UCI packing order for the non-PMI-based CSI report comprises one part with a mapping order of:
a CSI-RS resource indicator (CRI);
the RI;
zero-padding bits; and
a wide-band channel quality indicator (CQI) for a first transport block.

20. The method of claim 19, wherein the mapping order further comprises a layer indicator (LI) located between the RI and the zero-padding bits.

21. The method of claim 20, wherein the mapping order comprises the LI only when the UE is configured by the base station to include the LI in the non-PMI-based CSI report.

22. The method of claim 19, wherein the mapping order further comprises a wide-band CQI for a second transport block, wherein the wide-band CQI for the second transport block is located in the mapping order subsequent to the wide-band CQI for the first transport block.

23. The method of claim 22, wherein the wide-band CQI for the second transport block is included in the mapping order only for ranks greater than four.

24. The method of claim 1, wherein, for uplink control information (UCI) transmission on a physical uplink control channel (PUCCH) with wide-band CSI, a UCI packing order for the non-PMI-based CSI report comprises one part in which one or more PMI information fields are omitted.

25. The method of claim 1, wherein, for uplink control information (UCI) transmission on a physical uplink control channel (PUCCH) with wide-band CSI, a UCI packing order for the non-PMI-based CSI report comprises one part with a number of zero padding bits, wherein the zero padding bits keep a total payload size invariant.

26. The method of claim 1,
wherein, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts;
wherein a first payload size of a first part of the non-PMI-based CSI report is invariant; and
wherein a second payload size of a second part of the non-PMI-based CSI report depends on one or more values reported in the first part of the non-PMI-based CSI report.

27. The method of claim 26, wherein the first part of the non-PMI-based CSI report has a mapping order of:
a CSI-RS resource indicator (CRI);
the RI;
a wide-band channel quality indicator (CQI) for a first transport block; and
a sub-band differential CQI for the first transport block.

28. The method of claim 26, wherein the second part of the non-PMI-based CSI report has a mapping order of:
one or more wide-band terms; and
one or more sub-band terms.

29. The method of claim 28,
wherein the one or more wide-band terms comprise:
a wide-band CQI for a second transport block, wherein the wide-band CQI for the second transport block is included in the mapping order only for ranks greater than four; and
a layer indicator (LI),
wherein the one or more sub-band terms comprise:
one or more even sub-band terms; and
one or more odd sub-band terms,
wherein each one of the one or more even sub-band terms and the one or more odd sub-band terms comprises a sub-band CQI for the second transport block.

30. The method of claim 1, wherein, for uplink control information (UCI) transmission on a physical uplink control channel (PUCCH) with sub-band CSI or for UCI transmission on a physical uplink shared channel (PUSCH) with wide-band or sub-band CSI, a UCI packing order for the non-PMI-based CSI report comprises two parts in which one or more PMI fields are omitted.

31. The method of claim 1, wherein generating the non-PMI-based CSI report is responsive to the base station refraining from configuring the UE with a “pmi-FormatIndicator” parameter, or the base station configuring the UE with the “pmi-FormatIndicator” parameter set to “widebandPMI,” or the UE ignoring the “pmi-FormatIndicator” parameter.

32. The method of claim 1, wherein generating the non-PMI-based CSI report is responsive to the base station refraining from configuring the UE with a “codebookConfig” or “codebookConfig-r16” parameter, or the UE ignoring the “codebookConfig” or “codebookConfig-r16” parameter.

33. An apparatus for wireless communication by a user equipment (UE), comprising:
a memory; and
at least one processor coupled with the memory and configured to:
generate a non-precoding matrix indicator (PMI)-based channel state information (CSI) report, wherein the non-PMI-based CSI report includes a rank indicator (RI), wherein generating the non-PMI-based CSI report includes determining a first bit-width for the RI; and
transmit, to a base station, the non-PMI-based CSI report that includes the RI having the first bit-width.

34. A method of wireless communication by a base station, comprising:
transmitting, to a user equipment (UE), a channel state information (CSI) reporting configuration having a report quantity field with a value of “cri-ri-cqi;” and
receiving, in response to the CSI reporting configuration, a non-precoding matrix indicator (PMI)-based channel state information (CSI) report from the UE, wherein the non-PMI-based CSI report includes a rank indicator (RI) with a first bit-width.

35. An apparatus for wireless communication by a base station, comprising:
a memory; and
at least one processor coupled with the memory and configured to:
transmit, to a user equipment (UE), a channel state information (CSI) reporting configuration having a report quantity field with a value of “cri-ri-cqi;” and
receive, in response to the CSI reporting configuration, a non-precoding matrix indicator (PMI)-based channel state information (CSI) report from the UE, wherein the non-PMI-based CSI report includes a rank indicator (RI) with a first bit-width.
